(19) United States
(12) Patent Application Publication
(10) Pub. No.: US 2014/0327961 A1
(43) Pub. Date: Nov. 6, 2014

(54) Slider for Introduction into an Optical Path of a Light Microscope

(71) Applicants: Ingo Fahlbusch, Goettingen (DE); Georg Herbst, Goettingen (DE)

(72) Inventors: Ingo Fahlbusch, Goettingen (DE); Georg Herbst, Goettingen (DE)

(73) Assignee: CARL ZEISS MICROSCOPY GMBH, Jena (DE)

(21) Appl. No.: 14/360,756

(22) PCT Filed: Nov. 29, 2011
(86) PCT No.: PCT/EP2011/005979

§ 371 Date: May 27, 2014

(51) Int. Cl. G02B 21/26

(52) U.S. Cl. CPC G02B 21/26
USPC 359/392

(57) ABSTRACT

The invention relates to a slider for introduction into an optical path of a light microscope. Such a slider has a housing for arrangement on the light microscope, a holder which can be displaced in the housing in a displacement direction over a displacement length, an optical element which is held by the holder oriented with respect to an optical axis extending perpendicular to the displacement direction, and movement means for displacing the holder. The slider is characterised according to the invention in that at least the portion of the movement means which lies in the displacement direction within the displacement length lies, in a direction perpendicular to a plane fixed by the optical axis and the displacement direction, completely within a coverage area which is covered by the holder upon displacement thereof, wherein the coverage area is fixed by the optical axis as normal.

The present invention relates to a slider for introduction into an optical path of a light microscope according to the preamble to claim 1.

A generic slider has a housing for arrangement in or on the light microscope, a holder which can be displaced in the housing in a displacement direction over a displacement length, an optical element held by the holder so as to be oriented with respect to an optical axis extending perpendicular to the displacement direction, and movement means to displace the holder.

Such a slider is known from DE 101 12 706 B4. A threaded spindle is provided there as a movement means, said threaded spindle being driven by a motor. The spindle is arranged beside the holder so that the holder can be moved along the threaded spindle.

The available installation space for a slider on the light microscope is limited. Particularly if the light microscope has an insertion opening or a shaft for the slider, it is necessary for the dimensions of the slider to be adapted to the shaft. For example the shaft can have a width of 19 mm and a height of 3.7 mm. The slider of DE 101 12 706 B4 cannot be used in particular with such a greatly limited installation space. As a result of the arrangement of the threaded spindle and the motor described in DE 101 12 706 B4, the width of the slider exceeds the available installation space.

In the case of limited available installation space therefore conventional sliders without the movement means described in DE 101 12 706 B4 are used. Such sliders are completely removed from their inserted position with respect to the light microscope in order to move the optical element out of the optical path. This may be required during operation for example in the case of sliders which are designed as differential interference contrast sliders (DIC sliders). It may thus be desired to also perform fluorescence measurements on the same specimen without DIC slider. The shaft for the DIC slider is arranged, however, in many, in particular inverted, light microscopes in such a way that a removal of the DIC slider by hand is only possible upon rotation of the objective revolver. The specimen cannot thereby be constantly observed.

It can be regarded as an object of the invention to provide a slider for introduction into an optical path of a light microscope which, while having small dimensions, easily facilitates a displacement of the holder.

In addition it is a particular aim that the slider is to have a passage area which is as large as possible, in other words as large a portion of the effective width of the slider as possible is to be usable by the optical path.

This object is achieved by the slider having the features of claim 1.

Advantageous variants of the slider according to the invention are the subject matter of the dependent claims and are also described in the following description, in particular in association with the figures.

The slider of the abovementioned type has been developed according to the invention in that at least the portion of the movement means lying in the displacement direction within the displacement length lies in a direction perpendicular to a plane fixed by the optical axis and the displacement direction completely within the coverage area which is covered by the holder upon displacement thereof, wherein the coverage area is fixed by the optical axis as normal.

It can be regarded as a core idea of the invention to design and arrange the movement means in such a way that the width of the slider is determined at least in its end region, which is located on the optical path in the inserted state in the light microscope, essentially only through the housing and the holder received therein. The width in this end region is, however, not to be enlarged by the movement means.

The width of the slider is thereby to be understood to be its measurement in the direction transverse to the displacement direction. This transverse direction to the displacement direction means here the direction which, in the inserted state of the slider in the optical path of the light microscope, is also transverse to the optical path or to the optical axis of the light microscope.

An essential idea of the invention can be regarded as the recognition that the width of the slider can be kept particularly small in the abovementioned end region if no movement means is located in this end region beside the holder of the optical element. A portion of the movement means lying in the displacement direction within the area covered or swept by the holder upon displacement thereof does not therefore project beyond this area in the transverse direction. Instead, this portion of the movement means is arranged completely within the coverage area which is covered by the holder upon displacement thereof.

The invention facilitates a particularly advantageous configuration, wherein the value of an effectively usable expanse of an opening of the holder in the direction perpendicular to the displacement direction is greater than 48%, in particular between 48% and 68%, preferably between 53% and 63%, and particularly preferably between 56% and 60%, of an outer width of the slider. For example if the slider has a width of 19 mm the effectively usable expanse of the opening of the holder in this direction can be 11 mm. The opening of the holder is filled by the optical element received therein. In comparison with the prior art, the space available is thereby used significantly more effectively.

In addition it is possible according to the invention to utilise the fact that the space available for a slider or shaft on light microscopes is often greater at the end of the shaft remote from the optical path than on the optical path. Accordingly, in the displacement direction outside of the coverage area, a portion of the movement means can in principle also project beyond said coverage area.

The coverage area is thereby to be understood to be an area, of which the normal is parallel to the optical path of the light microscope, thus in the direction of the optical axis, if the slider is positioned on or in the light microscope.

If the housing of the slider is arranged on the light microscope the optical element can advantageously be displaced with the movement means between a retracted position, in which the optical element is not located in the optical path of the light microscope, and an inserted position, in which the optical element is located in the optical path. The housing can thus advantageously remain arranged on the light microscope and does not need to be moved in order to move the optical element out of the optical path. This is particularly advantageous if the area required to remove the slider from the light microscope is not available. If the slider is arranged on an objective revolver of the light microscope, the size of the area required for removal can depend upon the type and position of the objective revolver. Particularly in the case of inverted microscope bodies, rotation of the objective revolver may be necessary in order to remove the slider from the light microscope. In addition interference contours, which are produced for example through the microscope body, through add-on components such as a focus-hold and / or through the objective, can limit the area beside the slider on the light microscope so much that a removal of the slider is not possible. The invention offers the advantage here that the optical element can be moved out of the optical path via the holder and the movement means without the need to remove the slider. The slider can thus be left in particular in a shaft of the light microscope. The holder of the slider is not moved or is hardly moved out of the housing during a movement, meaning that the interference contour is not contacted.

The optical element can in principle be any means for influencing light and can in particular be in the form of a small plate. In the case of exemplary embodiments of the slider according to the invention the optical element has a prism, in particular a differential interference contrast prism (DIC prism), a λ/2 or λ/4 plate, a polariser, a colour filter and/or a diaphragm. In dependence upon the design of the optical element, different receiving positions or insert openings for the slider can be provided on the light microscope. Particular advantages are offered by the invention in the case of a design of the slider as a DIC or C-DIC slider which is used beside an objective of a light microscope where the available installation space is particularly limited. When using a DIC prism, measurements are often desired within a measuring sequence both with and without DIC prism. In this case it is possible, without adjusting the microscope components, to move the DIC prism via the holder and the movement means into the optical path and also to remove it therefrom. It is not therefore necessary to interrupt the measuring sequence for adjustments to the microscope.

The slider according to the invention can, however, also be advantageously used at other positions of the light microscope, for example between a specimen table and a light source for transmitted light or incident light. A possible embodiment of the slider according to the invention provides for a diaphragm so that the slider can be used for example as a field diaphragm or aperture diaphragm.

The holder of the optical element can be designed for example as a frame which completely surrounds the circumference of the optical element. Alternatively the frame can also be U-shaped and be open on the side pointing towards the optical path when the frame is in the retracted position, in which the optical element is not located in the optical path. The necessary displacement length for removal of the optical element from the inserted position in the optical path is thereby advantageously shorter.

Alternatively or additionally it can be provided that the optical element is bonded to the holder.

According to a preferred variant of the slider according to the invention the movement means has a spindle with thread and the holder has a nut, into which the spindle can engage. Insofar as the holder is formed with a nut, thus with an internal thread, a space-saving connection between the movement means and the holder can be achieved. The width of the slider is hereby advantageously not enlarged by the nut or the spindle. The spindle, which can also be described as a threaded rod, is thus located in the direction transverse to the displacement direction within the dimensions of the frame.

The housing can usefully have a housing opening which exposes the optical path if the slider is in the completely inserted state in the optical path of the light microscope. As the case may be, the optical element and/or the holder can engage in the optical path. According to a variant of the slider according to the invention the movement means are arranged spaced apart from the housing opening so as not to project into the optical path. If a spindle is present, it thus extends with its longitudinal axis towards the housing opening, but preferably ends before it. When the optical element is in the inserted position in the optical path, the holder is consequently only held with an end region of its internal thread on the spindle.

The dimensions of the housing opening can correspond in particular to the crosssection of the optical path at the receiving position for the slider on or in the light microscope. Having regard to the housing opening, a fundamental idea of the invention can be formulated in that at least a portion of the movement means lying in the displacement direction within the displacement length lies in the direction transverse to the displacement direction completely within the dimensions of the housing opening.

In order to rotate the spindle a coupling point for a key can be provided, for example a hexagonal recess, into which an Allen key can engage. Alternatively the spindle can have a grip portion which projects out of the housing. The grip portion can thus be manually rotated by a user.

According to a further preferred variant of the slider according to the invention it is provided that a spindle bearing shell to hold the spindle is present on the housing, that the spindle can be rotated relative to the spindle bearing shell for fine movement of the holder and that the spindle bearing shell and a region of the spindle adjacent thereto are magnetically formed in order to allow the spindle to be pulled away relative to the spindle bearing shell. For careful movement of the holder the spindle can advantageously be rotated here, for example via a grip element. In order to facilitate a rapid movement of the holder out of the optical path of the light microscope the spindle does not need to be rotated according to this embodiment. Instead, the magnetic coupling of the spindle on the spindle bearing shell can be released through simply pulling on the spindle or on its grip element.

According to a particularly preferred variant of the slider according to the invention the movement means has a motor. When using a spindle the motor can be connected to the spindle for rotation thereof. Due to the limited installation space it is preferable for the motor to be arranged in the displacement direction outside of the displacement length. In dependence upon the light microscope the width of the slider outside of the displacement length can be greater. It can be provided that the motor is arranged with its rotation axis at an angle to the displacement direction. The total length of the slider, thus the dimensions thereof in the displacement direction, is thus kept low. Thus, a motor can advantageously also be used when the region beside the receiving position of the slider on the light microscope is greatly limited by an interference contour, for example by a part of the body of the light microscope.

According to another advantageous embodiment of the slider according to the invention the movement means has a band—in particular closed—which extends over the displacement length and is connected to the holder. In order to move the band a rotatable drive roller can be present, around which the band is laid. The band can be formed in particular with or from a wire, a belt and/or a toothed belt. In order to facilitate a movement of the holder with the band, the band extends around the housing opening, wherein the two portions of the band extending in the displacement direction can intersect the region of the housing opening.

In order to manually activate the drive roller it can be provided that said drive roller has a toothing, via which the drive roller is connected to an adjusting screw. The adjusting screw then projects out of the housing and is thus accessible for a user. Alternatively a motor can also be connected to the drive roller.

The holder is connected to the band preferably at a connection point which is located on a portion of the band extending in the displacement direction. Lying opposite the connection point, the holder can have a guiding groove extending in the displacement direction. The band can then be moved within the guiding groove relative to the holder.

According to a further preferred embodiment of the slider according to the invention the movement means has a toothed rod which is arranged on the holder. In addition a rotating rod with toothed wheel is present, said toothed wheel being arranged engaging on the toothed rod to move the holder. As seen in the displacement direction, the rotating rod with toothed wheel is preferably arranged outside of the displacement length, over which the optical element can be displaced. According to variants with a motor the rotating rod is preferably a part of the motor.

A further variant of the slider according to the invention provides that the movement means has a miniature motor arranged on the holder to move the holder along a guide track of the housing. The miniature motor can in particular be a piezoelectric drive, wherein a movement is achieved by means of a piezoelectric actuator. The guide track of the housing can be formed for example by a groove, a wall of the housing provided with a toothed rod or also by a smooth housing wall. Alternatively the piezoelectric actuator can also be arranged on a housing wall and move the holder from there along the guide track.

Another preferred embodiment of the slider according to the invention is characterised in that the movement means has an entrainer with magnetic end region which can be moved in the displacement direction, that the holder has a magnetic region, via which a coupling with the entrainer can be produced, and that the movement means comprises a lever with a pivot joint, wherein the lever is arranged on the entrainer in order to facilitate a movement of the entrainer in the displacement direction by rotating the lever. In order to rotate the lever this can be arranged on a drive shaft of a motor. In order to release the magnetic coupling between the entrainer and the holder it is preferable for a non-magnetic reset to be present. This reset can be moved relative to the entrainer and relative to the holder in the displacement direction. Via the entrainer with magnetic end region the holder can thus be removed from an inserted position in the optical path, while the holder can be pushed back into the inserted position with the reset.

In particular in this embodiment it is preferable for a magnet to be present on an inner side of the housing beside the housing opening and for the holder to have a magnetic region, with which it can be held on the magnet in an inserted position in the optical path. In the inserted position in the optical path the holder is in a position, in which the optical element is oriented with respect to the housing opening. The inserted position of the optical element in the optical path of the light microscope can hereby advantageously be securely maintained even in case of interference. In addition it is possible to avoid the holder sliding out of the housing upon movement of said housing.

It can further be provided that at least one magnet is present on an outer side of the housing to hold the slider in a determined position if the slider has been introduced into the optical path of the light microscope. Thus, advantageously no unintentional movement of the slider takes place if the holder is moved relative to the housing, for example by rotating a spindle with a key.

In order to facilitate a movement of the holder in the displacement direction which is as secure and precise as possible, according to a further variant of the slider according to the invention the housing has in the displacement direction a guide track for the holder. The guide track can be formed with or on a housing wall in order to save materials and space.

It is further preferable for a position sensor to be present to determine the position of the holder relative to the housing. This position sensor can for example be a magnetic, light and/or ultrasonic sensor. Controlling the motor to move the holder into the optical path and out of it can thus be realised in dependence upon a signal of the position sensor. According to a simple embodiment the position sensor is adapted to ascertain the presence of the holder at a certain position.

The slider according to the invention can preferably have, on an outer side of the housing, electrical contact surfaces to transmit electrical signals to the motor of the movement means, to supply power to the motor and/or to transmit electrical signals to the position sensor or away from the position sensor. A control unit for outputting the electrical signals to the slider and for power supply can then be arranged outside of the slider on the microscope, whereby a particularly space-saving design of the slider is possible.

Further advantages and features of the invention are described below with reference to the attached schematic figures, in which:

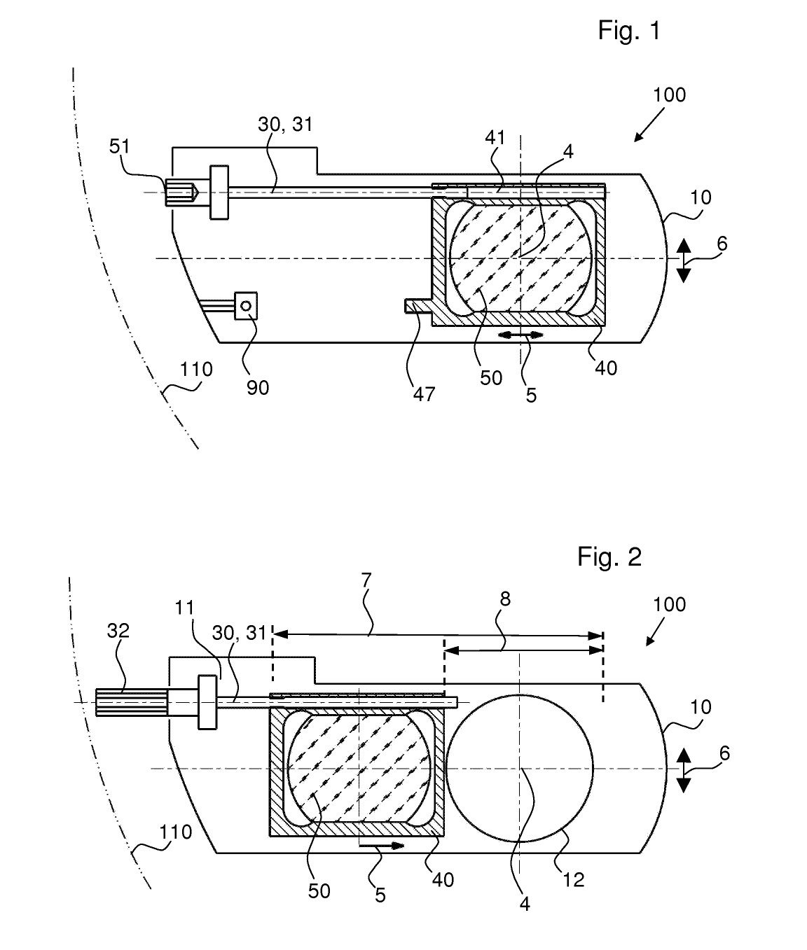

FIG. 1 shows a schematic illustration of a first exemplary embodiment of a slider according to the invention;

FIG. 2 shows a schematic illustration of a second exemplary embodiment of a slider according to the invention;

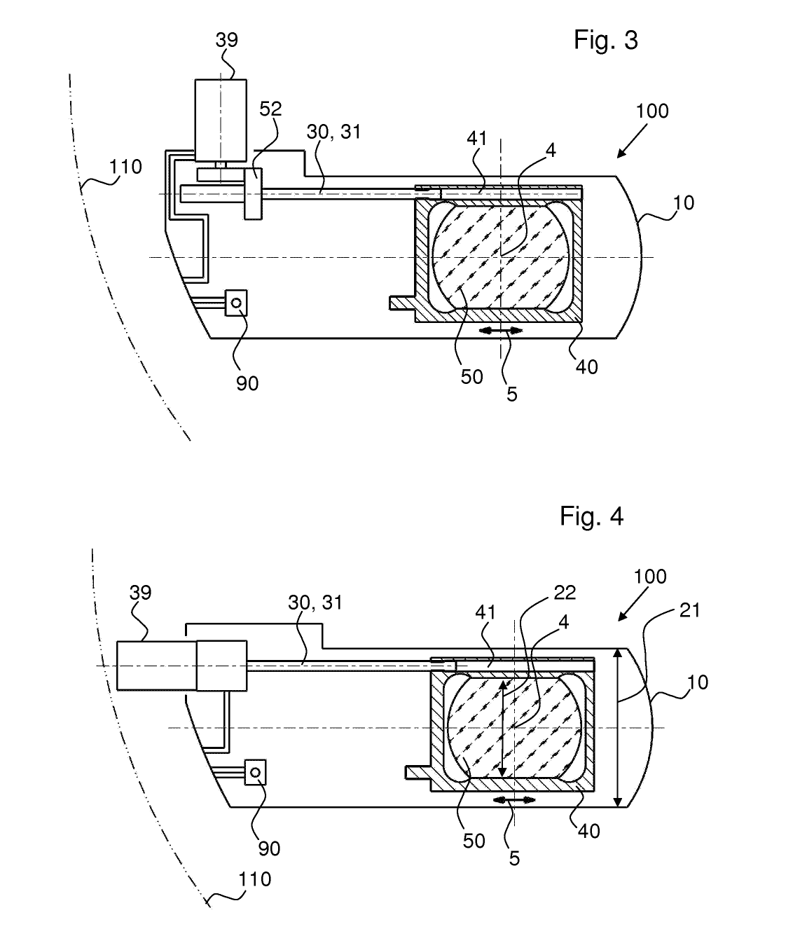

FIG. 3 shows a schematic illustration of a third exemplary embodiment of a slider according to the invention;

FIG. 4 shows a schematic illustration of a fourth exemplary embodiment of a slider according to the invention;

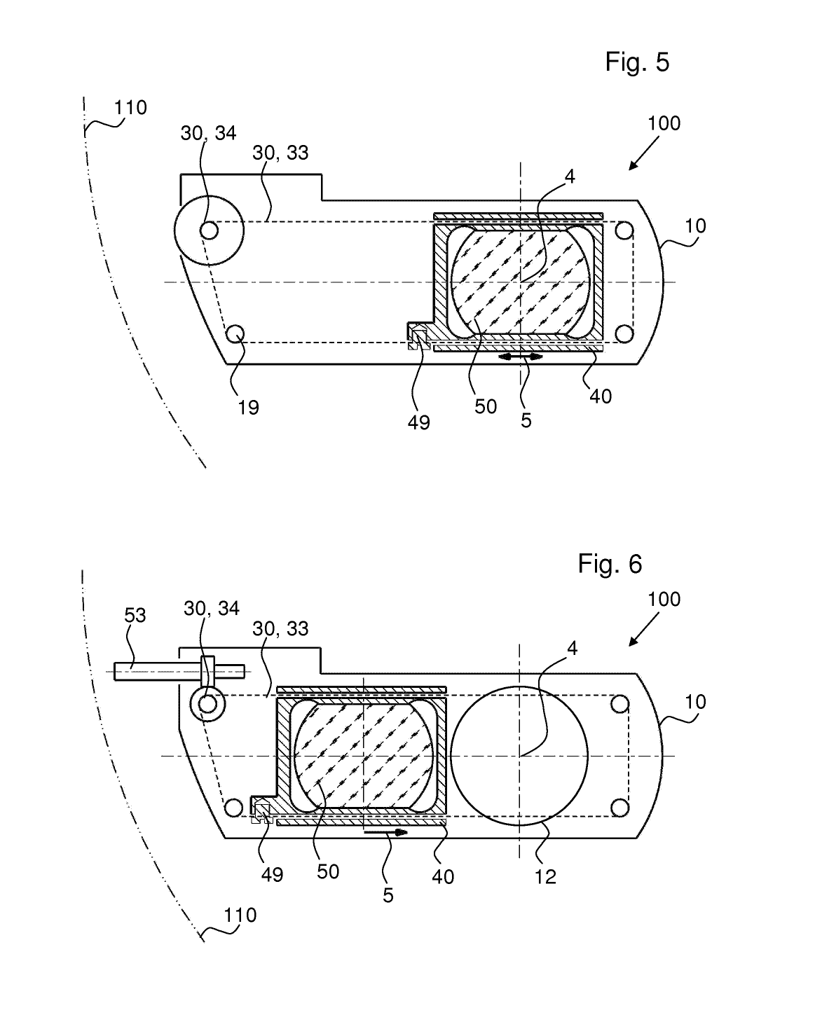

FIG. 5 shows a schematic illustration of a fifth exemplary embodiment of a slider according to the invention;

FIG. 6 shows a schematic illustration of a sixth exemplary embodiment of a slider according to the invention;

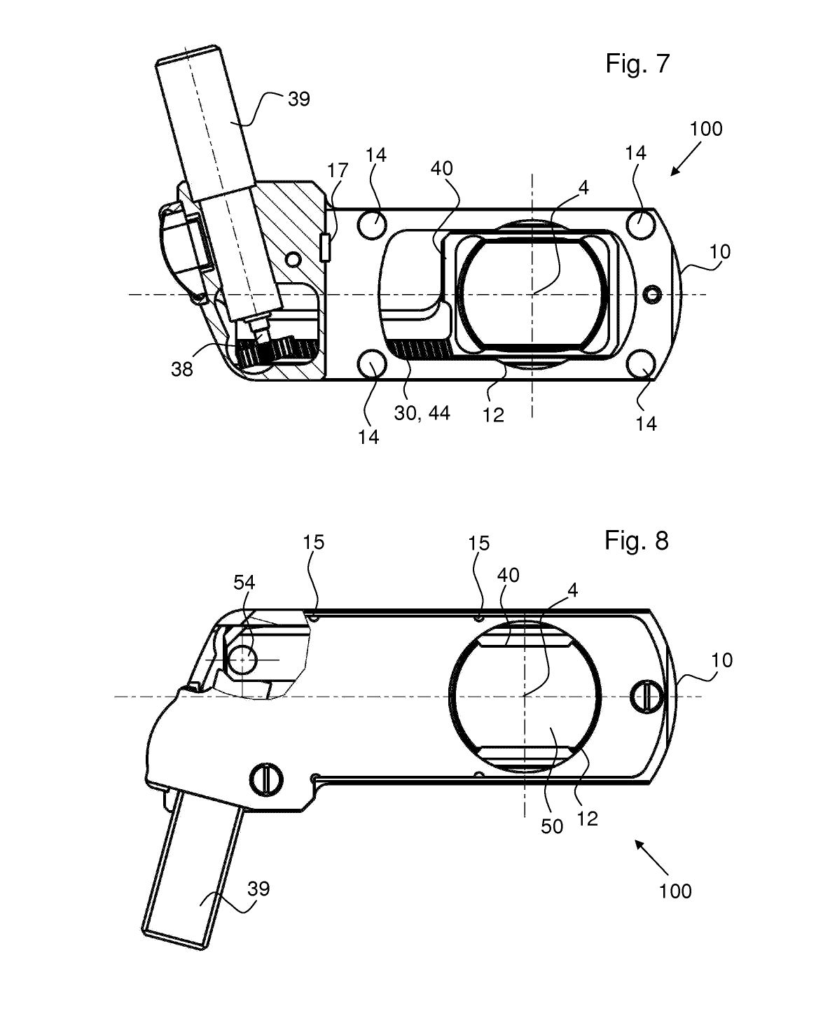

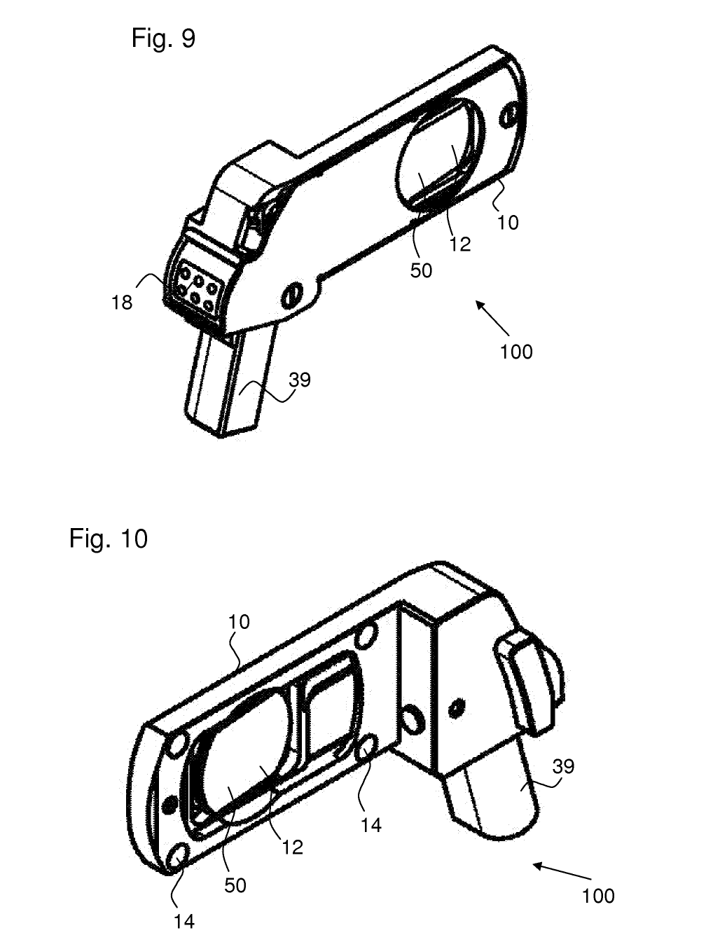

FIGS. 7 and 8 show a seventh exemplary embodiment of a slider according to the invention from different schematic views;

FIGS. 9 and 10 show the seventh exemplary embodiment of FIGS. 7 and 8 in different schematic perspective illustrations;

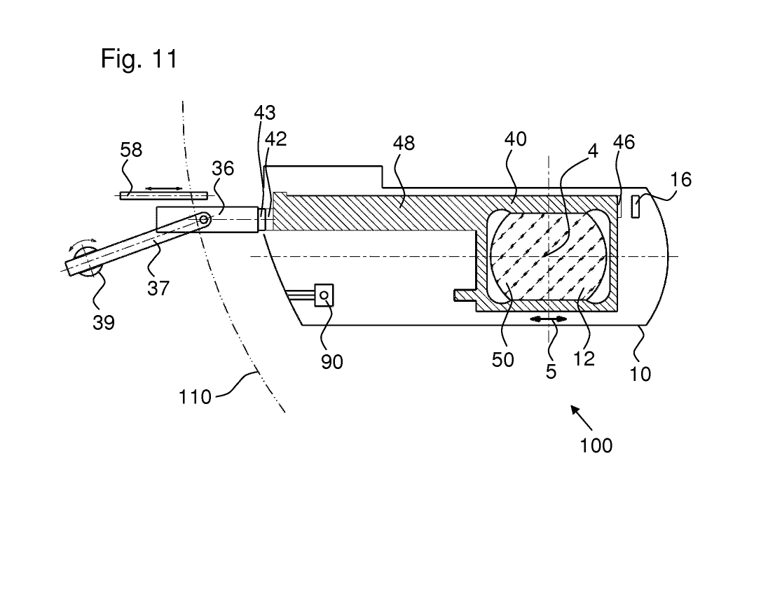

FIG. 11 shows a schematic illustration of an eighth exemplary embodiment of a slider according to the invention.

The same components and those working in the same way are identified in the figures as a rule with the same reference numerals.

FIG. 1 shows a schematic illustration of a first exemplary embodiment of a slider 100 according to the invention for introduction into an optical path of a light microscope. Essential components of the slider 100 are a housing 10, a holder 40, an optical element 50 held by the holder 40 and movement means 30 to move the holder 40 within the housing 10.

The holder 40 can be moved along a displacement direction 5 with the movement means 30. The holder 40 can hereby be displaced between the position shown in FIG. 1, in which the optical element 50 is located in the optical path of the light microscope, and a retracted position, in which the holder 40 and the optical element 50 are located out-side of the optical path.

A situation where the holder 40 and the optical element 50 are located in the retracted position is shown in FIG. 2 for a second exemplary embodiment of the slider according to the invention. In addition the displacement length 7, over which the holder 40 is moved from the inserted position into the retracted position, is shown there. The displacement length 7 can, as shown in FIG. 2, be intended as a displacement path 8 of that outer edge of the holder 40 which points, in the position retracted from the optical path, towards the optical path of the light microscope, plus the expanse of the holder 40 in the displacement direction 5.

In particular if the slider 100 has been introduced in an insert opening of a light microscope (not shown here), the space available to remove the slider 100 can be greatly limited. In the example shown this free space is limited by the interference contour 110 which can be produced for example by a part of the body of the light microscope. Due to the interference contour 110, in the case illustrated, the slider 100 cannot therefore be removed from the optical path of the light microscope.

In order to nonetheless be able to expose the optical path, according to the invention a movement means 30 is provided. Through this movement means 30, the holder 40 and the optical element 50 can be moved into the optical path and out of it without movement of the housing 10 of the slider 100 being necessary.

The housing 10 has a housing opening 12 so that the optical path of the light microscope is not impaired by the housing 10 when the holder 40 is retracted.

In the exemplary embodiment shown in FIG. 1 the movement means 30 comprises a spindle 31 extending in the displacement direction 5.

At an end of the spindle 31 facing away from the housing opening 12, said spindle 31 is mounted on the housing 10. At the opposite end of the spindle 31 the holder 40 is arranged which has a nut 41 for coupling to the spindle 31. A guide track for the holder 40 in the displacement direction 5 is provided by housing walls (not shown here), so that a rotation of the spindle 31 leads to a movement of the holder 40 in the displacement direction 5.

The installation space available for the slider 100 on the light microscope is as a rule greatly limited. The width of a slider may typically be only approximately 2 cm or less in a transverse direction 6 extending perpendicular to the displacement direction 5. A height of the slider, in FIG. 1 thus from the drawing plane outwards, may in many cases even be a maximum of only 4 mm. In order to facilitate, even with these extremely small dimensions, a displacement of the holder 40 within the housing 10, according to the invention a particular arrangement of the movement means 30 is provided. In particular the region which is covered by the holder 40 upon displacement thereof is to be used for the movement means 30. Coverage is thereby to be defined in a top view onto the holder 40, thus in a view along the optical path of the light microscope.

According to the invention at least the portion of the movement means 30 which lies within the displacement length 7 is not to project in the transverse direction 6 out of the region which is covered by the holder 40 upon displacement thereof. The movement means 30 is preferably, for the whole coverage length 8, within the area covered by the holder 40 upon displacement thereof. The space requirement of the slider 100 in the transverse direction 6 can thereby advantageously be kept particularly small. The space in the displacement direction 5 is hereby used particularly efficiently.

Outside of the coverage length 8, the available space in the transverse direction 6 is larger in many light microscopes. In this portion the movement means 30 can thus also extend or expand further in the transverse direction 6.

In the embodiment of the movement means 30 as a spindle 31 shown in FIG. 1, the compact arrangement according to the invention leads to the spindle 31 extending towards the housing opening 12, thus in the direction of the optical path of the light microscope. In order to avoid the spindle 31 projecting into the optical path, said spindle 31 ends before the housing opening 12. If the holder 40 has been inserted into the optical path it is consequently only held at its outer edge by the spindle 31.

For rotation of the spindle 31, said spindle 31 has a coupling point 51. For example a hexagonal recess can be provided as a coupling point 51 so that the spindle 31 can be rotated with an Allen key (not shown). The Allen key can also be inserted in a motorised manner. In order avoid wear and damage, a round head hex screw which is resiliently mounted can preferably be used.

Particularly in the case of motorised adjustment of the holder 40 it is useful to provide a position sensor 90. In the embodiment shown in FIG. 1 the position sensor 90 is arranged on a side of the housing 10 lying opposite the housing opening 12 in order to be able to ascertain a retracted position of the holder 40. The holder 40 can have a flag 47 which covers the position sensor 90 when the holder 40 is retracted and thus triggers a detection signal.

In order to achieve a defined movement of the optical element 50 when using a motor, electronic control means (not shown) connected to the position sensor 90 are adapted to carry out a reference run. This allows it to be ascertained how many steps or revolutions of the motor are necessary in order to displace the holder 40 between the inserted and the retracted position. Particularly precise results can be achieved with a second position sensor (not shown) which is arranged to ascertain an inserted position of the holder 40 in the optical path.

As a result of the compact structure of the slider 100 according to the invention, under certain circumstances the holder 40 conceals a part of the optical path when it is inserted into the optical path. As can be seen from FIGS. 1 and 2, this concealed region is determined decisively by the size of the internal thread 41 of the holder 40. It is thus desirable to provide a diameter which is as small as possible for the internal thread 41 and consequently also for the spindle 31. Such a long spindle 31 with a small diameter is difficult to manufacture without faults, whereby the spindle 31 may not run smoothly. In order to ensure that the slider 100 is not moved out of its place on the light microscope even with non-smooth running of the spindle 31, holding means are preferably provided. In this connection, in the exemplary embodiment of a slider 100 according to the invention shown in FIG. 7, magnets 14 are provided on an outer side of the housing 10. Through magnetic contact surfaces on the light microscope the slider 100 can then be held in a certain position. Alternatively the housing 10 of the slider 100 can also be made of a magnetisable material. In principle, a receiving shaft on the light microscope for the slider 100 can indeed also be equipped with springs to hold the slider 100. However, the space required for this is greater in comparison with that of magnetic holding.

The slider 100 shown in FIG. 2 differs from that of FIG. 1 through the design of the movement means 30. In FIG. 2 a spindle 31 is indeed also provided. It is not, however, rotated via a coupling point with for example a hex key. Instead, the spindle 31 has in FIG. 2 a grip element 32. This projects out of the housing 10 so that it can be rotated by hand by a user.

The spindle 31 is held on the housing 10 via a spindle bearing shell 11. In the example shown the spindle bearing shell 11 and a region of the spindle 31 adjacent thereto can be magnetically formed. The spindle 31 can thus be removed from the spindle bearing shell 31, whereby the holder 40 can be removed from the optical path of the light microscope. Such a long rotation of the spindle 31 is advantageously superfluous. A removal of the spindle 31 is only possible, however, if this is not prevented by an interference contour 110. If the slider 100 is brought into an insert opening beside an objective of the light microscope, the interference contour 110 can depend upon the rotation position of the objective revolver. Depending upon the rotation position it may thus be possible to remove the spindle 31.

The slider 100 shown in FIG. 2 may be designed more cost-effectively than the slider 100 of FIG. 1. As it is possible to adjust it by hand, the slider 100 of FIG. 2 can be used preferably in upright microscope bodies. In the case of inverted microscopes on the other hand the accessibility to the grip element can be limited.

In addition the accessibility can also be limited by a specimen support table. In the case of a microscope used in an incubation chamber, the slider is as a rule likewise not accessible to a user. It is thus advantageous to provide a motor to move the spindle.

Such an exemplary embodiment of a slider 100 with motor 39 is shown in FIG. 3. Here, the spindle 31 is equipped with a spur gear 52, on which a pinion of the motor 39 can engage. A rotation axis of the motor 39 is hereby arranged transverse to the longitudinal direction of the spindle 31. The space requirement of the slider 100 towards the interference contour 110 is thus smaller.

It can, however, also be provided that the longitudinal direction of the spindle 31 coincides with the rotation axis of the motor 39. Such an exemplary embodiment is shown in FIG. 4. Through a direct connection between the motor 39 and the spindle 31, as is the case in FIGS. 3 and 4, the likelihood of interference is further reduced in comparison with the indirect motor control of FIG. 1.

FIG. 4 shows furthermore the width 21 of the slider 100. This width 21 can be for example 19 mm in the region of the housing opening. At the end remote from the housing opening, on which the motor 39 is arranged here, the width of the housing can also have greater values. FIG. 4 shows furthermore an effectively usable expanse 22 of an opening of the holder 40 in the direction perpendicular to the displacement direction 5. This effectively usable expanse 22 is filled by the optical element 50 and is to be as close as possible to the width 21 of the slider 100. In the embodiment shown the effectively usable expanse is 11 mm and thus approximately 60% of the width 21 of the slider 100.

FIGS. 5 and 6 show exemplary embodiments of a slider 100 according to the invention schematically, wherein the movement means 30 has a closed band 33 instead of a spindle 31. This band 33 can also be described as a transmission element and in particular be formed by a wire, a belt or a toothed belt. The holder 40 is connected to the band 33, by means of a screw 49 in the examples shown. Deflection means 19 and a drive roller 34 are present on the housing 10, the band 33 being arranged around the drive roller 34. By rotating the drive roller 34 this leads therefore to a movement of the band 33 and thus a displacement of the holder 40 in the displacement direction 5.

In the embodiment shown in FIG. 5 the drive roller 34 projects out of the housing 10. The drive roller 34 can thus be advantageously rotated by hand, in particular with a single finger.

In contrast, in the exemplary embodiment of FIG. 6 an adjusting screw 53 is present, which engages via an inclined toothing on the drive roller 34. The drive roller 34 is arranged here within the housing 10, while the adjusting screw 53 projects out of the housing 10. The band 33 is preferably designed to be very thin so that it only covers a very small part of the optical path of the light microscope.

A further variant of a slider according to the invention is shown schematically in FIG. 7 from the front and in FIG. 8 rotated by 180°. FIGS. 9 and 10 show schematic perspective views of this embodiment from the front and from the rear. In comparison with FIGS. 1 to 6, more components of the housing 10 are illustrated here.

The embodiment of FIGS. 7 to 10 differs from the preceding embodiments through the design of the movement means 30. The movement means 30 here comprises a motor 39 and a toothed rod 44. The toothed rod 44 is fixedly connected to the holder 40 and extends from it in the displacement direction. A rotating rod 38 of the motor 39 is provided with pinions which engage in the toothed rod 44. By rotating the rotating rod 38 the toothed rod 44 and the holder 40 can thus be moved between an inserted position in the optical path of the light microscope and a retracted position from the optical path.

In the example shown the toothed rod 44 has an inclined toothing, that is to say the depressions of the toothed rod 44 are not perpendicular to the displacement direction. The rotation axis of the motor 39 can thereby be arranged inclined with respect to the displacement direction, thus at an angle to the perpendicular in relation to the displacement direction. The overall expanse of the slider 100 in the displacement direction is hereby advantageously lower.

According to this variant the toothed rod 44, or a part thereof, constitutes the portion of the movement means which lies in the displacement direction within the displacement length. The motor 39 is on the other hand—as is also the case with the other embodiments—arranged outside of the displacement length, where larger widths of the slider 100 are allowed.

As shown in FIG. 8, the toothed rod 44 has a magnet 54. The magnet 54 is preferably arranged relative to a magnetic region of the housing 10 so that it holds the holder 40 in a position inserted in the optical path of the optical microscope. Alternatively or additionally, a magnetic field sensor can be present on the housing 10 to determine the position of the magnet 54 in order to thus determine an inserted position of the holder 40 in the optical path. Other embodiments of a position sensor or a plurality of position sensors are likewise possible.

As shown in FIGS. 7 and 8, magnets 14, 15 and 17 are provided on the outer sides of the housing 10 to hold the slider 100 on the light microscope, for example in a shaft. By means of the magnet 17, in particular in the displacement direction 5, a certain position can be reached between the slider 100 and the light microscope. The magnets 15 are /arranged on an outer side which is adjacent to the outer side with the magnets 14 and 17. The slider 100 can hereby be held, with respect to all three spatial directions, at a certain position on the light microscope. The light microscope can be made of magnetisable steel at corresponding points. By means of the magnets 14, 15 and 17 the optical element 50 can thus advantageously be positioned precisely with respect to the optical axis 4 of the light microscope.

Electrical contact surfaces 18 of a feed circuit board of the slider 100 can be recognised in FIG. 9. By means of these contact surfaces 18, the motor 39 and other components, for example the position sensor, can be supplied with power and data. The feed circuit board preferably also has a control unit, for example a microprocessor, to control the motor 39 in dependence upon the measurement data of the position sensor.

In place of the embodiment of the movement means 30 illustrated in FIGS. 7 to 10 through a motor and a toothed rod, a miniature drive, such as for example a piezoelectric actuator, can also be provided as movement means. This can be connected to the housing or to the holder. By means of a conductor path, for example a foil path, the miniature drive can be connected to the electrical contact surfaces for power supply and data transmission. It is useful here if a position sensor is present and a control unit is adapted to measure a reference run of the holder with the aid of the position sensor. The miniature drive can then be controlled in operation in dependence upon the measurement data of the reference run.

While in this embodiment the control unit is arranged as a constituent part of the feed circuit board within the slider 100 or on the slider 100, the control unit can alternatively also be arranged on the light microscope, for example on a revolver carriage of the light microscope. In order to keep the wear of the electrical contact surfaces 18 low in case of contact with the control unit, the control unit is preferably mounted to be displaceable on the revolver carriage. Contact pins of the control unit can thereby be raised, before rotating the revolver plate, from the contact surfaces of the slider 100, whereby this reduces the wear of the electrical contact surfaces. For secure contact between the control unit and the electrical contact surfaces of the slider 100, the control unit or its contact pins are preferably resiliently mounted. In addition the contact surfaces 18 on the slider 100 can be designed so that the contact pins of the control unit can slide thereon during rotation.

A further embodiment of a slider 100 according to the invention is shown in FIG. 11.

The holder 40 is connected here to an extension rod 48 which extends in the connecting direction. Alternatively the holder 40 can also be formed integrally with the extension rod 48. The extension rod 48 or at least a region thereof constitutes the portion of the movement means which is located in the displacement direction within the displacement length and lies, in the direction transverse to the displacement direction, completely within the area covered by the holder 40 upon displacement thereof.

The extension rod 48 has a magnet 42 at its end facing away from the holder 40. A coupling with an entrainer 36, which is likewise provided with a magnet 43, can be realised with this magnet 42. The entrainer 36 can be moved in the displacement direction 5 to move the holder 40. In this connection the entrainer 36 is connected via a pivot joint to a lever 37. This lever 37 is arranged on the drive shaft of a motor 39 (not shown here). Via the pivot joint, a rotation of the motor 39 can thus be conveyed into a linear movement of the entrainer 36 coupled to the extension rod 48.

In order to release the magnetic coupling between the extension rod 48 and the entrainer 36, in the embodiment shown a reset 58 is present. This can press the extension rod 48 and thus the holder 40 via a motor (not shown) in the displacement direction 5 towards the housing opening 12. In order to release the magnetic coupling, preferably the reset function 58 and the entrainer 36 are moved simultaneously in opposing directions.

A magnet 46 is arranged on the holder 40 to hold the holder 40 in an inserted position in the optical path of the light microscope. Said magnet 46 can produce a coupling with a magnet 16 which is fixed to the housing on a side of the housing opening 12 lying opposite the extension rod 48. The magnets 46 and 16 for holding the holder 40 in the inserted position in the optical path are designed for a weaker magnetic coupling than the magnets 42 and 43, via which the entrainer 36 removes the holder 40 from the inserted position in the optical path.

It is also ensured by means of the magnets 46 and 16 that upon movement of the slider 100, for example during rotation of the objective revolver of the light microscope, the extension rod 48 and the holder 40 do not slip out of the housing 10.

The course of the interference contour 110 can depend upon a rotation position of the objective revolver of the light microscope. For example the interference contour 110 can be formed by a focus-hold of the light microscope. In the example shown in FIG. 11 the entrainer 36 and the lever 37 project beyond the interference contour 110. Consequently a displacement of the extension rod 48 and the holder 40 can only be realised with them in certain rotation positions of the objective revolver, in which no interference contour 110 is present, as in FIG. 11. Nonetheless, even in this embodiment, the advantages according to the invention can be achieved, in particular that a displacement of the optical element 50 held by the holder 40 is possible between an inserted position in the optical path of the light microscope and a retracted position from the optical path without the housing 10 having to be removed from the light microscope.

The slider 100 according to the invention advantageously additionally has a very small width, thus a very small dimension in a direction transverse to the displacement direction, whereby the slider 100 according to the invention can thus also be used with greatly limited installation space availability.

Furthermore according to advantageous variants of the slider 100 according to the invention, motorised movement of the optical element 50 is facilitated. A comfortable adjustment of the optical element 50 can hereby be realised even when the slider 100 is not accessible for a user. This can be the case in particular if the light microscope is located in an incubation chamber. However, also in case of accessibility of the slider 100 for a user, the operating comfort can be increased by motorised control.

### LIST OF REFERENCE NUMERALS

4 Optical axis
5 Displacement direction
6 Direction transverse to the displacement direction 5
7 Displacement length of the holder 40
8 Displacement path of the holder 40
10 Housing
11 Spindle bearing shell
12 Housing opening
14 Magnet on the housing 10 to hold the slider 100
15 Magnet on the housing 10 to hold the slider 100
16 Magnet on the housing 10 to hold the holder 40 in the housing 10
17 Magnet on the housing 10 to hold the slider 100
18 Electrical contact surfaces
19 Deflection means for the band 33
21 Width of the slider 100
22 Effectively usable expanse of the opening of the holder 40
30 Movement means
31 Spindle
33 Band
34 Drive roller for the band 33
36 Entrainer
37 Lever
38 Rotating rod which engages in the toothed rod 44
39 Motor
40 Holder
42 Magnetic region of the holder 40 for coupling with the entrainer 36
41 Nut of the holder 40 for coupling to the spindle 31
43 Magnetic end region of the entrainer 36
44 Toothed rod
46 Magnetic region of the holder 40 for coupling with the magnet 16
48 Extension rod on the holder 40
49 Screw of the holder 40 for fixing to the band 33
47 Flag of the holder 40 for detection by the position sensor 90
50 Optical element
51 Coupling point for contacting the movement means 30
52 Spur gear
54 Magnet of the toothed rod 44
58 Reset
90 Position sensor
100 Slider
110 Interference contour

1. Slider for introduction into an optical path of a light microscope, having
a housing (10) for arrangement in or on the light microscope,
a holder (40) which can be displaced in the housing (10) in a displacement direction (5) over a displacement length (7),
an optical element (50) which is held by the holder (40) oriented with respect to an optical axis (4) extending perpendicular to the displacement direction (5), and
movement means (30) for displacement of the holder (40),
wherein
at least the portion of the movement means (30) which lies in the displacement direction (5) within the displacement length (7) lies in a direction (6) perpendicular to a plane fixed by the optical axis (4) and the displacement direction (5) completely within a coverage area, which is covered by the holder (40) upon displacement thereof, wherein the coverage area is fixed by the optical axis (4) as normal.

2. Slider according to claim 1,
wherein
the movement means (30) has a spindle (31) with thread and
the holder (40) has a nut (41), into which the spindle (31) can engage.

3. Slider according to claim 2,
wherein
a spindle bearing shell (11) to hold the spindle (31) is present on the housing (10), the spindle (31) can be rotated relative to the spindle bearing shell (11) for fine movement of the holder (40), and
the spindle bearing shell (11) and a region of the spindle (31) adjacent thereto are magnetically designed in order to allow the spindle (31) to be pulled away from the spindle bearing shell (11).

4. Slider according to claim 1,
wherein
the movement means (30) has a closed band (33) which extends over the displacement length (7) and is connected to the holder (40), and
a rotatable drive roller (34) is present, around which the band (33) is laid, to move the band (33).

5. Slider according to claim 4,
wherein
the closed band (33) is formed with at least one of a wire (33), a belt (33) and a toothed belt (33).

6. Slider according to claim 1,
wherein
the movement means (30) have a toothed rod (44) which is arranged on the holder (40), and
a rotating rod (38) with toothed wheel is present, said toothed wheel being arranged engaging on the toothed rod (44) to move the holder (40).

7. Slider according to claim 1,
wherein
the movement means (30) have an entrainer (36) with magnetic end region (43) which can be moved in the displacement direction (5),
the holder (40) has a magnetic region (42), via which a coupling with the magnetic end region (43) of the entrainer (36) can be produced, and
the movement means (30) have a lever (37) with pivot joint,
wherein the lever is arranged on the entrainer (36) in order to facilitate a movement of the entrainer (36) in the displacement direction (5) by rotating the lever (37).

8. Slider according to claim 1,
wherein
the housing (10) has a housing opening (12) which exposes the optical path in the completely inserted state of the slider in the optical path of the light microscope, and
the movement means (30) are arranged spaced apart from the housing opening (12).

9. Slider according to claim 1,
wherein
the movement means (30) have a motor (39) which is arranged in the displacement direction (5) outside of the displacement length (7) and with its rotation axis at an angle to the displacement direction (5).

10. Slider according to claim 1,
wherein
the movement means (30) have a miniature motor arranged on the holder (40) to move the holder along a guide track of the housing (10).

11. Slider according to claim 10,
wherein
the miniature motor has a piezoelectric actuator.

12. Slider according to claim 1,
wherein
at least one magnet (14) is present on an outer side of the housing (10) to hold the slider in a certain position if the slider has been introduced into the optical path of the light microscope.

13. Slider according to claim 1,
wherein
the housing (10) has in the displacement direction (5) a guide track for the holder (40).

14. Slider according to claim 1,
wherein
a position sensor (90) is present to determine the position of the holder (40) relative to the housing (10).

15. Slider according to claim 14,
wherein
the position sensor (90) is at least one of a magnetic, light and ultrasonic sensor.

16. Slider according to claim 1,
wherein
the holder (40) has a magnetic region (46),
a magnetic region (16) is present on the housing (10), and
the magnetic region (46) of the holder (40) and the magnetic region (16) of the housing (10) are arranged oriented with respect to the housing opening (12) to hold the holder (40) with the optical element (50).

17. Slider according to claim 1,
wherein
electrical contact surfaces (18) for transmitting electrical signals to a motor (39) of the movement means (30), for at least one of power supply to the motor (39) and transmitting electrical signals to the position sensor (90) or away from the position sensor (90) are present on an outer side of the housing (10).

18. Slider according to claim 1,
wherein
the optical element (50) has at least one of a prism, a differential interference contrast prism, a λ/2 or λ/4 plate, a polariser, a colour filter and a diaphragm.

19. Slider according to claim 1,
wherein
an effectively usable expanse of an opening of the holder (40) in the direction (6) perpendicular to the displacement direction (5) is greater than 48%, in particular between 48% and 68%, preferably between 53% and 63%, and particularly preferably between 56% and 60%, of an outer width of the slider.
